(19) United States
(12) Patent Application Publication
(10) Pub. No.: US 2007/0263395 A1
(43) Pub. Date: Nov. 15, 2007

(54) Uninterruptible power supply connection light

(76) Inventors: Robert Stephens, Minneapolis, MN (US); Yeh Shou-ting, Taipei (TW); Eric Chan, New York, NY (US); Shigeru Natsume, Brooklyn, NY (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/430,551

(22) Filed: May 9, 2006

(51) Int. Cl. F21S 8/08

(52) U.S. Cl. 362/418

(57) ABSTRACT

The present invention is a connection light attached to an uninterruptible power supply (UPS) for viewing wiring connections to the rear surface of the UPS and to nearby equipment. The connection light is operable under normal conditions as well as during a power failure. In some configurations, the connection light is extendible in three dimensions and can be pointed in any direction. The connection light may draw power directly from the UPS, or it may contain its own rechargeable battery. In some configurations, the light is detachable from the UPS.

### FIELD OF THE INVENTION

The present invention relates generally to uninterruptible power supply (UPS) units. More particularly, it relates to a connection light—a light built into a UPS to illuminate obscure regions around computer equipment, particularly during power failures.

### BACKGROUND OF THE INVENTION

Many computer systems are protected against electrical power failures by uninterruptible power supply (UPS) units. A UPS is a battery backup for the normal electrical system into which hardware devices, including a computer and peripheral devices (e.g., a monitor, network adapted storage, printer, or scanner) can be plugged. In addition to providing battery backup, a typical UPS will also contain electrical circuitry to suppress power surges.

During a failure of house power (i.e., power from the public electrical grid accessed through building wall outlets), the UPS continues to provide power to the hardware plugged into it for a limited amount of time. The interval of backup service so provided allows users to take remedial steps to mitigate the outage.

In larger systems, a UPS may allow operations to continue until an electrical generator is brought online; a more substantial UPS unit, may provide power for several hours. Henceforth throughout this document, the focus will be on small computer systems, such as ones that might be found in a home, a home office, or a small business. The present invention has applicability in some large system contexts, however, and our focus on small systems environments should not be regarded as a limitation of the invention.

In the case of a small system, the UPS typically provides backup power for only a few minutes to permit orderly shutdown of the computer system. The UPS sounds an audible alarm to alert users that the level of power provided from the electric company through the wall outlet is below a specified level or is zero, and that the computer equipment is now relying for power, albeit temporarily, upon the UPS itself. If lucky enough to hear the alarm, users will typically save any open new or modified data files, dose all executing software applications, exit the operating system, and turn off the computer.

In the event of an outage, it is not uncommon for a user to want to change how hardware components are connected electrically. The user might want to take advantage of the brief minutes of power available from the battery to complete a few outstanding tasks requiring some rearrangement of the wiring. For example, a printer might be plugged into a surge suppressor that is no longer functional due to the power failure. Being able to print a few sheets of paper by means of UPS power might satisfy a pressing user need. Perhaps in an emergency situation such as a severe storm, the user might want to charge a mobile phone with the limited power still available from the battery.

A power outage is often followed by a number of power surges and drops as the electrical system attempts to come back online. During a thunderstorm, the power being out does not necessarily prevent lightening strikes from sending bursts of current through the electrical system. Rather than unnecessarily trust their valuable hardware and data (particularly information that has not yet been backed up) to surge suppressors (whether the UPS itself or external ones), some people prefer to disconnect selected critical devices from the power grid if given the opportunity.

Despite the fact that newer models of many types of components (e.g., network router, keyboard, mouse, printer) are frequently wireless, a tangle of wires above, below, behind, and under the computer desk or table is still commonplace. During a power outage, there may be little or no light available to identify the desired wires and move connections around appropriately.

An ordinary flashlight might be obtained with the idea of keeping it dose by the computer system for use, among other situations, in power outages. Despite best intentions of all concerned, however, when a flashlight is most needed, its batteries will often be dead, or it cannot be located at all.

### SUMMARY OF THE INVENTION

The present invention is designed to address these problems by a novel modification to a UPS, the incorporation of a built-in “connection light,” providing illumination to the rear of the UPS, where one or more electrical components are plugged in for backup, and surrounding area. In one embodiment, the connection light has a fixed position on the rear face of the UPS unit, the illumination coming through a lens directing light downward along the back face of the UPS. In this embodiment, the connection light can be turned on or off by pressing its face inward toward the body of the UPS. In other embodiments, the connection light, while still attached to the UPS, is free to be moved and pointed in three dimensions, behaving essentially like a flashlight. In such embodiments, the light may be on a retractable cord; in others, on a bendable snake cable. Other embodiments are also possible.

The connection light will continue to operate for some time during a power outage. Even during periods when electricity to the computer equipment is being supplied normally, proximity of the UPS to the computer system will allow the connection light to illuminate those dark and concealed places, such as below the desktop and behind the computer hardware, that are filled with electrical equipment wires critical to system operation. Because it is integrated into the UPS, a component characteristically heavy and cumbersome to move, the connection light cannot stray from where it is needed for its specific purpose of facilitating visibility and maintenance of the computer equipment.

### BRIEF DESCRIPTION OF THE DRAWINGS

FIG. 1 is a side view of a UPS showing an embodiment of the connection light attached to the back of the UPS in a fixed position.

FIG. 2 is a side view cross section through the rear of the UPS showing an embodiment of the connection light having a self-retracting cable, in its rest configuration.

FIG. 3 is a rear view of a UPS showing the self-retracting connection light from the previous figure in an extended configuration.

FIG. 4 is a rear view of the UPS showing an embodiment of the invention, powered through a snake cable, in its rest configuration.

FIG. 5 is a side view of the UPS corresponding to the previous figure.

FIG. 6 is a rear view of the UPS showing a snake cable embodiment of the invention, in an extended configuration.

### DETAILED DESCRIPTION OF THE INVENTION

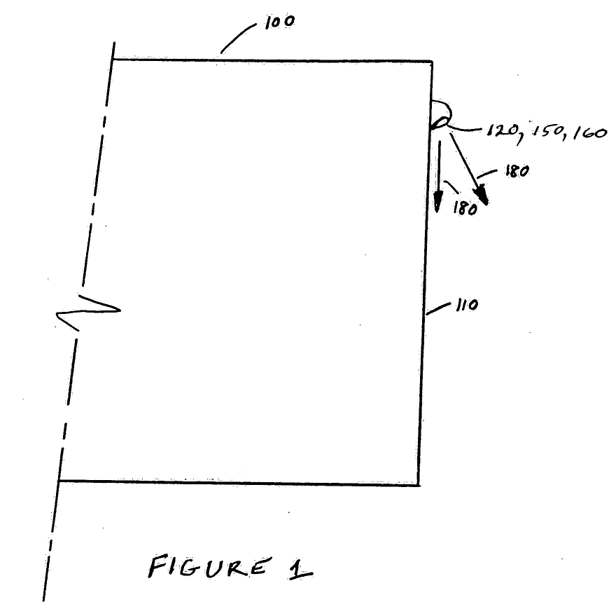

FIG. 1 is a side view of a UPS 100 unit illustrating one embodiment of a connection light 20, in this case a connection light 120 having a fixed position within the back face of a UPS unit. The connection light 120 structure contains a lens 150 that directs light from a lamp 160 within the connection light 120 generally downward as indicated by the light ray arrows 180 shown. An aspect of the invention is how the lamp 160 is turned on and off. In the preferred embodiment, the connection light 120 is located on the rear face 110 proximately to the top of the UPS and is switched on or off simply by pressing it inward toward the body of the UPS. This arrangement allows a user to easily turn the connection light 120 on or off simply by feel, without the user having to crawl behind the UPS. In the event of a power outage, the lamp 160 can be configured to turn on automatically. The connection light 120 can be always be turned off manually, and optionally can be configured so that its lamp 160 turns off automatically after a previously specified period of time. Any of the embodiments discussed subsequently can have similar manual and automatic methods of being turned on and off.

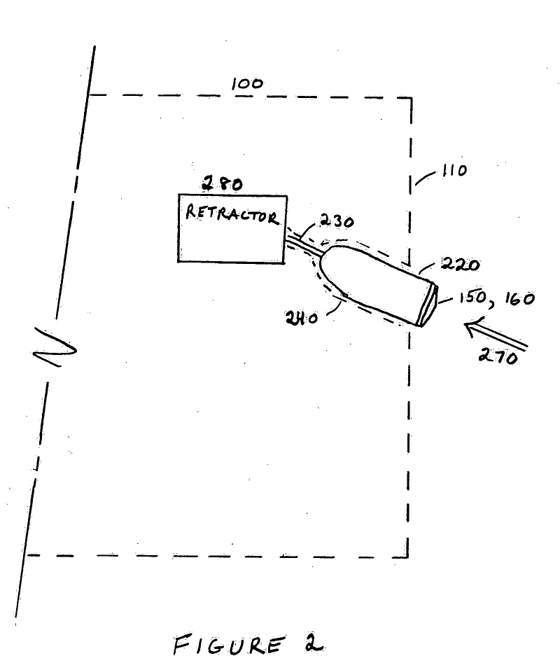

FIG. 2 is a side view of a UPS 100 unit depicting a cross-section through its rear face 110 (shown with a dashed line pattern), illustrating another embodiment of a UPS connection light 20. The UPS unit describes a housing 240 or cavity in which the connection light 220 rests in its retracted position. A self-retracting cable 230 carries power from the UPS battery 190 (contained within the UPS and not shown) to the connection light 220. Automatic retraction of the self-retracting cable 230 is implemented by a retractor 280 apparatus within the UPS 100.

In the preferred embodiment, the housing 240 is designed so that the lamp 160 is aimed at an angle below the horizontal in order to shine on wiring (not shown) on the floor below or behind the UPS 100. The connection light 220 is turned off and on by simply pressing its lens 150, generally toward the front of the UPS 100; that is, in the direction indicated by the arrow 270 shown in the figure.

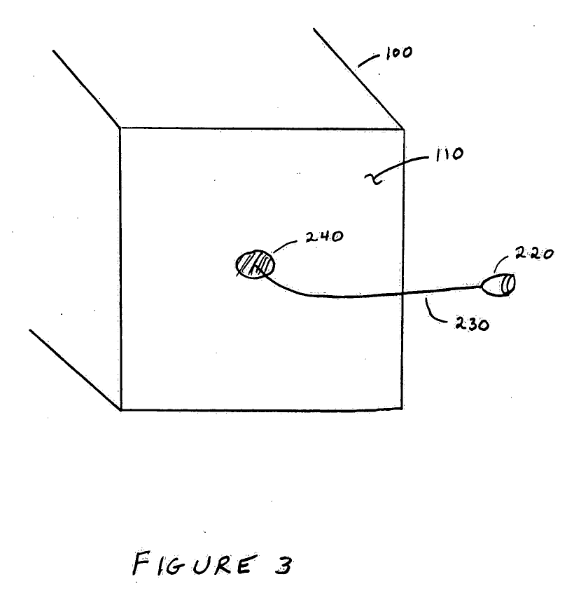

FIG. 3 is a rear view of the UPS 100 corresponding to the embodiment shown in FIG. 2. This figure illustrates the connection light 220 in an extended position. The flexible self-retracting cable 230 allows the lamp 160 to be pointed in any direction. Like a power cable for many household upright vacuum cleaners, pulling gently on the connection light 220 will allow the self-retracting cable 230 to extend from the rest configuration within the housing 240 (as shown in FIG. 2), ultimately to the maximum length of the self-retracting cable 230. Tugging sharply, or jerking the self-retracting cable 230, generally perpendicular to the rear of the UPS will cause the retractor 280 located within the UPS 100 to pull the self-retracting cable 230 back into the UPS 100 until it again achieves its rest position within the housing cavity 240.

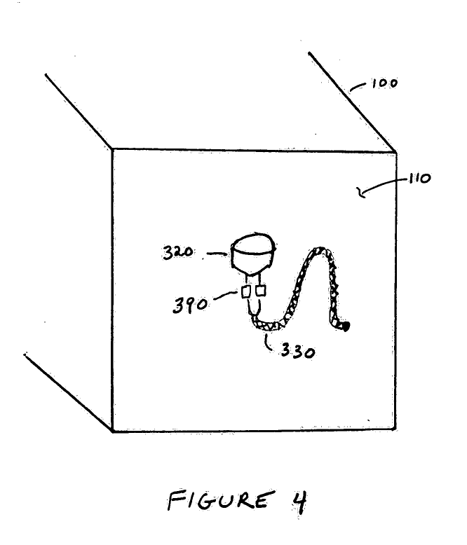

Another embodiment of the connection light 20 is shown in FIG. 4. In this case, the snake connection light 320 is connected electrically to the UPS 100 by a snake cable 330, one that is bendable perpendicular to its axis but not compressible along its axis. Hence, we will refer to this embodiment as a snake connection light 320. The snake cable 330 is sufficiently stiff that it will remain rigid unless pressure is applied to bend it. As with the self-retracting cable, power is carried through a wire enclosed within the snake cable 330 to the snake connection light 320.

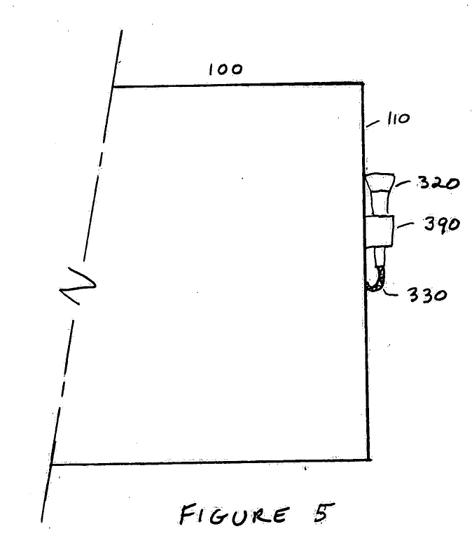

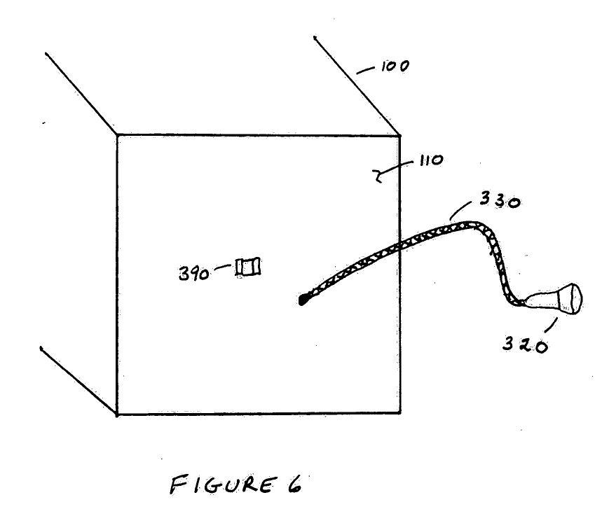

FIG. 5 shows the embodiment of FIG. 4 from the side of the UPS 100. The snake connection light 320, located at the end of the snake cable 330, is attached to the rear of the UPS with an attachment device 340 such as a snap-in clamp, a magnet, or VELCRO fabric strips. However, because of the rigidity of the snake cable 330 in this embodiment, an attachment device 340 is actually optional. FIG. 6 shows a snake connection light 320 in an extended configuration. The snake connection light 320 can be equipped with any of the numerous types of switches known in the art for turning electrical illumination on and off. Some examples are a twisting bezel, a sliding switch, and a rocker switch.

An important aspect of the invention, independent of the cable and attachment configurations, is the power source for the connection light 20. During non-outage periods, the lamp 160 within the connection light 20 will be powered indirectly from the house current, not depleting the UPS battery 190. During an outage, there are two alternative power sources. First, the lamp 160 can draw power from the UPS battery 190. Since the UPS battery 190 may only provide power for a very short time, however, a better approach is to include one or more rechargeable batteries 400 (not shown) within the body of the connection light 20. These rechargeable batteries 400 will increase their charge up to a maximum level while normal power is available. During an outage, the connection light 20 could remain functional, relying for power upon its own batteries, for up to several hours of use, far longer than the time during which power is available from a small system UPS battery 190. In fact, in an alternative embodiment utilizing rechargeable batteries, the connection light 20 can be integrated into a computer component other than a UPS 100, such as a server computer tower, with efficacy equal to incorporating the connection light 20 into a UPS 100.

The present invention is not limited to all the above details, as modifications and variations may be made without departing from the intent or scope of the invention. Consequently, the invention should be limited only by the following claims and equivalent constructions.

What is claimed is:

1. An apparatus for illuminating wiring connections, comprising:
a) an uninterruptible power supply (UPS) containing a battery and including a top surface and a rear surface;
b) a connection light including a lamp and a lens and adapted to illuminating the back of the UPS.

2. The apparatus of claim 1, wherein the connection light is attached to the rear surface of the UPS proximate to the top surface of the UPS and wherein the lens directs light from the lamp when illuminated downward along the rear surface of the UPS.

3. The apparatus of claim 1, wherein connection light can be switched on or off by pressing the connection light.

4. The apparatus of claim 1, further comprising:
c) a power cable extendibly attaching the connection light to the UPS and allowing the connection light when the cable is extended to be pointed in any direction in three dimensions, the cable providing electrical power from the UPS to the connection light.

5. The apparatus of claim 4, further comprising:
d) a retractor within the UPS adapted to retracting the cable into the UPS to a retracted configuration of the connection light corresponding to the minimum extension of the cable.

6. The apparatus of claim 5, wherein the UPS describes a cavity providing a housing for the connection light in the retracted configuration.

7. The apparatus of claim 6, wherein the orientation of the housing causes the connection light in its retracted configuration to be pointed in a direction below the horizontal.

8. The apparatus of claim 1, wherein the connection light turns on automatically in the event of failure in house power.

9. The apparatus of claim 1, wherein the connection light once illuminated turns off automatically after a previously specified interval of time.

10. The apparatus of claim 1, wherein during a failure of house power, the power to illuminate the connection light is provided by the battery within the UPS.

11. The apparatus of claim 1, wherein the connection light contains a rechargeable battery, said rechargeable battery maintaining a charge up to a maximum level during periods when power is available from the UPS, and independently providing power to the connection light when power is unavailable from the UPS.

12. The apparatus of claim 1, wherein the power cable is contained within a snake cable adapted to being bent but not to being compressed, and that rigidly maintains its shape unless bending pressure is applied to it.

13. The apparatus of claim 12, wherein the connection light is detachable from the power cable.

14. The apparatus of claim 12, further comprising:
d) means for attaching the connection light to a face of the UPS.

15. A method for illuminating wiring connections near a computer system, comprising:
a) switching on a connection light attached to an uninterruptible power supply (UPS) by a cable providing power from the UPS to the connection light;
b) extending the cable from a rest position within, or proximate to, a face of the UPS to a second position; and
c) pointing the connection light toward the wiring.

16. An apparatus for illuminating computer wiring connections, comprising:
a) a computer tower;
b) a connection light, containing a rechargeable battery;
c) a power cable extendibly attaching the connection light to the computer and allowing the connection light when the cable is extended to be pointed in any direction in three dimensions, the cable providing electrical power from the computer, thereby allowing the battery to increase its charge up to a maximum level while the computer is receiving electrical power a source external to the computer.

17. The apparatus of claim 16, wherein the connection light is detachable from the power cable.
